(19) United States
(12) Patent Application Publication
(10) Pub. No.: US 2013/0017434 A1
(43) Pub. Date: Jan. 17, 2013

(54) SECONDARY BATTERY NEGATIVE ELECTRODE, NON-AQUEOUS ELECTROLYTE SECONDARY BATTERY AND METHOD OF MANUFACTURING THE SAME

(71) Applicants: Masao Shimizu, Hitachi (JP); Katsunori Nishimura, Hitachiota (JP)

(72) Inventors: Masao Shimizu, Hitachi (JP); Katsunori Nishimura, Hitachiota (JP)

(73) Assignee: HITACHI, LTD., Tokyo (JP)

(21) Appl. No.: 13/546,316

(22) Filed: Jul. 11, 2012

(30) Foreign Application Priority Data
Jul. 11, 2011 (JP) 2011-152451

(51) Int. Cl. H01M 4/64; H01M 4/82

(52) U.S. Cl. 429/156; 429/211; 29/623.1

(57) ABSTRACT

A non-aqueous electrolyte secondary battery negative electrode having a negative electrode compound layer formed on a current collector, in which the negative electrode compound layer is constituted by a lower negative electrode compound layer and an upper negative electrode compound layer, the lower negative electrode compound layer is formed on the current collector, the upper negative electrode compound layer is formed on the lower negative electrode compound layer, the lower negative electrode compound layer includes a negative electrode active material, the upper negative electrode compound layer includes a conducting material and a binder, and a conducting aid and the binder are locally present on the surface side of the upper negative electrode compound layer.

### BACKGROUND OF THE INVENTION

1. Field of the Invention

The present invention relates to a secondary battery negative electrode, a non-aqueous electrolyte secondary battery using the secondary battery negative electrode, and a method of manufacturing the same.

2. Background Art

Secondary batteries, such as lithium ion batteries, are attracting attention as batteries for electric vehicles or power storage from the viewpoint of environmental issues. Since secondary batteries are lighter than lead batteries and nickel-cadmium batteries, and have characteristics of high output and high energy density, secondary batteries are promising for the near future.

However, for the lithium ion batteries in the related art, there is demand for further improvement in battery characteristics. For example, for improvement in the battery materials, manufacturing of a secondary battery negative electrode for which two or more compound layers having different properties are used is proposed (JP-A-2009-064574 and JP-A-2010-108971). JP-A-2004-179005 is proposed as another technique in the related art.

### SUMMARY OF THE INVENTION

JP-A-2009-064574 discloses an invention of a negative electrode in which plural kinds of negative electrode active materials are used, a first negative electrode layer is provided near a negative electrode current collector side, and a second negative electrode layer having a high charging rate capability is provided away from the negative electrode current collector side. JP-A-2010-108971 discloses an invention of a negative electrode in which a conducting adhesive layer obtained by mixing carbon particles and a binding agent is formed on a current collector, and, furthermore, an electrode composition layer obtained by mixing an electrode active material, a conducting material, and a binding agent is formed on the conducting adhesive layer. Both inventions aim to improve the battery characteristics.

A negative electrode, which is a subject of the invention, can be produced by attaching negative electrode slurry obtained by preparing, mixing, and stirring an active material where lithium ions can be inserted and separated, a conducting material, a binder, such as a poly (vinylidene fluoride) (PVDF)-based binder or styrene butadiene rubber (SBR), and an organic solvent or water to a current collector sheet, such as copper, by the doctor blade method or the like, then, heating the solution so as to dry the organic solvent, and pressurization-molding the mixture through roll pressing.

However, for the active material and the conducting material, there are cases in which properties, such as the grain diameters of carbon particles and a specific surface area, are different, and, furthermore, there are cases in which the active material and the conducting material have different properties even when manufactured from the same original material depending on the presence and absence of a coating on carbon particle surfaces. Therefore, the coated compound layer does not necessarily have a uniform form.

When the compound layer of the obtained negative electrode is observed using a scanning electron microscope (SEM), the states of the active material particles, the conducting material particles, and the binder can be confirmed. On the cross-sectional surface of the compound layer, there are an arrangement in which conducting material agglomerates attach between a plurality of active material particles, an arrangement in which conducting material agglomerates are locally present mainly at gaps between a plurality of active material particles, and the like. In addition, since the binder is generally a highly resistant material, in a case in which a large amount of the binder is included in the interface between the current collector of the battery and the active material particles, a case in which a large amount of the binder is included in a plurality of the active material particles on the surface of the compound layer, or a case in which a large amount of the binder is included between the active material particles, there is a problem in that conducting is hindered between the active materials, the internal resistance of the compound layer increases, and the rate capability decreases.

Occurrence of the above problems, such as agglomeration of the conducting material and uneven distribution of the binder, results in not only degradation of the charge and discharge capacity but also separation of the particles of the active material and the conducting material from the current collector, uneven electric currents, and the like, thereby degrading the reliability of battery qualities.

In such circumstances, there is strong demand for an increase in the capacity of the battery and a negative electrode for which a robust and strong conducting network is formed.

The invention provides a non-aqueous electrolyte secondary battery that can solve the above problems, improve the rate capability, and suppress an increase in the irreversible capacity. Particularly, an object of the invention is to increase the capacity of a lithium ion battery.

The problems that the invention is to solve are solved by means as shown below. Here, the non-aqueous electrolyte secondary battery typically refers to a non-aqueous electrolyte secondary battery including a positive electrode, a negative electrode, where lithium ions can be inserted and separated, and a porous film that separates the positive electrode and the negative electrode, and the non-aqueous electrolyte secondary battery can also be applied to secondary batteries for which other alkali metal ions are used.

(1) A non-aqueous electrolyte secondary battery negative electrode includes a negative electrode compound layer formed on a current collector, in which the negative electrode compound layer is constituted by a lower negative electrode compound layer and an upper negative electrode compound layer, the lower negative electrode compound layer is formed on the current collector, the upper negative electrode compound layer is formed on the lower negative electrode compound layer, the lower negative electrode compound layer has a negative electrode active material, the upper negative electrode compound layer has a conducting material and a binder, and a conducting aid and the binder are locally present on the surface side of the upper negative electrode compound layer.

(2) In the non-aqueous electrolyte secondary battery negative electrode, the upper negative electrode compound layer includes the negative electrode active material, and the content of the negative electrode active material in the upper negative electrode compound layer is larger than the content of the conducting material in the upper negative electrode compound layer.

(3) In the non-aqueous electrolyte secondary battery negative electrode, the content of the conducting material in the negative electrode compound layer is 1 wt % to 6 wt %.

(4) In the non-aqueous electrolyte secondary battery negative electrode, the film thickness of the upper negative electrode compound layer is larger than the film thickness of the lower negative electrode compound layer.

(5) In the non-aqueous electrolyte secondary battery negative electrode, the content of the binder in the negative electrode compound layer is 0.5 wt % to 2.0 wt %.

(6) In the non-aqueous electrolyte secondary battery negative electrode, the thickness of the lower negative electrode compound layer is two times or more the surface roughness of the current collector.

(7) In the non-aqueous electrolyte secondary battery negative electrode, when the distance from an interface between the current collector and the negative electrode compound layer toward the surface of the negative electrode compound layer is represented by d₁ in the film thickness direction of the negative electrode compound layer, and the distance from the surface of the negative electrode compound layer toward the interface between the current collector and the negative electrode compound layer is represented by d₂ in the film thickness direction of the negative electrode compound layer, the average area fraction of the conducting material and the binder in the negative electrode compound layer in 0 μm≦d₁≦10 μm is two times or more the average area fraction of the conducting material and the binder in the negative electrode compound layer in 0 μm≦d₂≦10 μm.

(8) In the non-aqueous electrolyte secondary battery negative electrode, the negative electrode compound layer includes a viscosity improver.

(9) Anon-aqueous electrolyte secondary battery in which the non-aqueous electrolyte secondary battery negative electrode is used.

(10) A battery module in which a plurality of the non-aqueous electrolyte secondary batteries is used.

(11) A method of manufacturing a non-aqueous electrolyte secondary battery negative electrode having a negative electrode compound layer formed on a current collector includes a process of forming a lower negative electrode compound layer which includes a negative electrode active material, and does not include a conducting material and a binder on the current collector, and a process of forming an upper negative electrode compound layer which includes a conducting material and a binder on the lower negative electrode compound layer, in which a conducting aid and the binder are locally present on the surface side of the upper negative electrode compound layer.

According to the invention, a non-aqueous electrolyte secondary battery that can improve the rate capability and suppress an increase in the irreversible capacity can be obtained. Objects, configurations, and effects which are not described above will be clarified in the following description of embodiments.

### BRIEF DESCRIPTION OF THE DRAWINGS

FIG. 1 is a structural view of a compound layer.

FIG. 2 is the area fractions (1) of second carbon and a binder in the compound layer thickness direction of a first embodiment of the invention.

FIG. 3 is the area fractions (2) of the second carbon and the binder in the compound layer thickness direction of a comparative example.

FIG. 4 is the area fraction (3) of the binder in the compound layer thickness direction of the first embodiment of the invention.

FIG. 5 is a cross-sectional view of a coin-type lithium ion battery of the first embodiment of the invention.

FIG. 6 is a structural view of a cylindrical lithium ion battery of the first embodiment of the invention.

FIG. 7 is a battery module including the cylindrical lithium ion batteries of the first embodiment of the invention.

FIG. 8 is a view showing an analysis area of the compound layer.

FIGS. 9A and 9B are data tables of Examples 1 to 6 and Comparative Examples 1 to 3.

### DETAILED DESCRIPTION OF THE INVENTION

Hereinafter, embodiments of the invention will be described using the accompanying drawings and the like. The following embodiments simply show specific examples of the invention, the invention is not limited to the embodiment, and a person skilled in the art can make a variety of modifications and corrections within the scope of the technical ideas that are disclosed in the present specification. In addition, in all the drawings for describing the embodiments, the same reference sign will be given to components having the same function, and description thereof will not be repeated.

In order to increase the charge and discharge capacity of a non-aqueous electrolyte secondary battery, the invention is accomplished by as little second carbon which easily absorbs a binder and has as large a specific surface area as possible being contained on the current collector side of a compound layer. The non-aqueous electrolyte secondary battery according to the invention has a positive electrode and a negative electrode, where lithium ions can be inserted and separated, a separator that separates the positive electrode and the negative electrode, and an electrolytic solution. Hereinafter, the above elements will be described. A positive electrode and a negative electrode where, other than lithium ions, magnesium ions, sodium ions, and the like can be inserted and separated may be used. Hereinafter, a non-aqueous lithium secondary battery will be described.

Firstly, the positive electrode of the non-aqueous lithium secondary battery will be described. The positive electrode is constituted by a positive electrode compound layer including a positive electrode active material, a conducting material, and a binder, and a positive electrode current collector.

The positive electrode active material that can be used in the lithium ion battery according to the invention includes a lithium-containing oxide. Examples of the lithium-containing oxide that can be used include oxides having a layer structure, such as LiCoO₂,LiNiO₂, LiMn_{1/3}Ni_{1/3}Co_{1/3}O₂, and LiMn_{0.4}Ni_{0.4}Co_{0.2}O₂, lithium-manganese complex oxides having a spinel structure, such as LiMn₂O₄ and Li₁₊ₓMn₂₋ₓO₄, and the above oxides in which some of Mn is substituted with another element, such as Al or Mg.

Generally, the positive electrode active material has a high resistance, and therefore the electric conductivity of the positive electrode active material is compensated for by mixing carbon powder as a conducting material. Since the positive electrode active material and the conducting material are both powders, a binder is mixed in so as to bind the powder, and, at the same time, the powder layer is attached to the positive electrode current collector as the compound layer.

As the conducting material, natural graphite, artificial graphite, cokes, carbon black, amorphous carbon, or the like can be used. When the average grain diameter of the conducting material is smaller than the average grain diameter of the positive electrode active material powder, the conducting material becomes liable to be attached to the surfaces of positive electrode active material grains, and there are many cases in which the electric resistance of the positive electrode is decreased by a small amount of the conducting material. Therefore, the material of the conducting material may be selected based on the average particle diameter of the positive electrode active material.

The positive electrode current collector may be a material that does not easily dissolve in an electrolytic solution, and an aluminum foil is frequently used.

The positive electrode can be produced by a method in which positive electrode slurry obtained by mixing the positive electrode active material, the conducting material, the binder, and an organic solvent is coated on the current collector using a blade, that is, by the doctor blade method. The positive electrode slurry coated on the current collector is heated so as to dry the organic solvent, and pressurization-molded through roll pressing. The positive electrode compound layer is produced on the current collector by drying the organic solvent in the positive electrode slurry. The positive electrode in which the positive electrode compound layer and the current collector are adhered to each other can be produced in the above manner.

A negative electrode is constituted by a negative electrode compound layer including a negative electrode active material, the conducting material, and the binder, and a negative electrode current collector. There are cases in which the conducting material is not used in the negative electrode compound layer.

Graphite or amorphous carbon that can electrochemically absorb and emit lithium ions can be used as the negative electrode active material of the non-aqueous lithium ion battery according to the invention, and the negative electrode active material has no limitation on the kind or material as long as the negative electrode active material can absorb and emit lithium ions. Since the negative electrode active material being used is generally used in a powder form, the binder is mixed so as to bind the powder, and, at the same time, a layer including the negative electrode active material is attached to the negative electrode current collector as the compound layer.

First carbon is a carbon material that is used as the negative electrode active material and can absorb and emit lithium ions. Examples thereof that can be used include natural graphite, artificial graphite, amorphous carbon, and the like. Natural graphite that is coated to decrease the irreversible capacity is preferred. As the first carbon, the above material may be used solely or in mixture of two or more kinds.

The second carbon is used as the conducting material, is conductive, and substantially absorbs no lithium ions. The specific surface area is preferably 10 m²/g or more, and a carbon material, such as coke, carbon black, acetylene black, carbon fiber, Ketjen black, carbon nanotubes, mesocarbon microbeads, or vapor-grown carbon fibers, may be used. Furthermore, the second carbon is more preferably added to the first carbon in an upper negative electrode compound layer that will be described below. Thereby, the capacity can be increased. In examples described below, carbon black is used, but the second carbon is not limited thereto. For example, carbon black may be substituted with any of the above second carbon, and plural kinds of different carbons may be mixed in and used.

In addition to poly (vinylidene fluoride) (PVDF), a fluorine-based polymer, such as polytetrafluoroethylene, styrene butadiene rubber (SBR), acrylonitrile rubber, or the like may be used as the binder. Binders other than the binders listed above may be used as long as the binders are not decomposed at the reduction potential of the negative electrode and do not react with a non-aqueous electrolyte or a solvent that dissolves the non-aqueous electrolyte. A well-known solvent that fits for the binder may be used as the solvent that is used to prepare the negative electrode slurry. For example, a well-known solvent, such as water or the like in the case of SBR, acetone, toluene, or the like in the case of PVDF, can be used. The content of the binder in the negative electrode compound layer is desirably 0.5 wt % to 2.0 wt %. When the content of the binder is greater than 2.0 wt %, there is a possibility of an increase in the internal resistance. The above materials may be used solely or in a mixture of two or more kinds as the binder.

A viscosity improver can be used in order to adjust the viscosity of the slurry. For example, carboxymethyl cellulose (CMC) can be used for SBR. Other than CMC, PVP, PEO, AQUPEC, or the like can be used as the viscosity improver. The above materials can be used singly or in a mixture of two or more kinds as the viscosity improver.

The negative electrode current collector should be a material that does not easily alloy with lithium, and examples thereof include copper, nickel, titanium, or the like, or a metallic foil including an alloy of the above metals. Particularly, a copper foil is frequently used.

The negative electrode can be produced by attaching negative electrode slurry obtained by mixing the negative electrode active material, the conducting material, the binder, and the organic solvent to the current collector by the doctor blade method or the like, then, heating the slurry so as to dry the organic solvent, and pressurization-molding the mixture through roll pressing. The negative electrode compound layer is produced on the current collector by drying the organic solvent in the negative electrode slurry.

The separator is constituted by a polymer-based material, such as polyethylene, polypropylene, or ethylene tetrafluoride, and is inserted between the positive electrode and the negative electrode which are produced in the above manner. The separator and the electrodes are made to sufficiently hold the electrolytic solution so as to secure the electrical insulation between the positive electrode and the negative electrode and enable lithium ions to migrate between the positive electrode and the negative electrode.

A coin-type battery is produced by sequentially laminating the cylindrically-cut positive electrode, the separator, and the negative electrode, housing the laminate in a coin-shaped container, installing a lid on the top portion, and then swaging the entire battery.

In the case of a cylindrical battery, an electrode group is manufactured by winding the positive electrode and the negative electrode in a state in which the separator is inserted between the positive electrode and the negative electrode. Instead of the separator, a sheet-shaped solid electrolyte or gel electrolyte including a lithium salt or a non-aqueous electrolytic solution held in a polymer, such as polyethylene oxide (PEO), polymethacrylate (PMA),polyacrylonitrile (PAN), poly(vinylidene fluoride) (PVDF), or poly(vinylidene fluoride)-hexafluoro-propylene copolymer (PVDF-HFP), can also be used. In addition, when the electrodes are wound at two axes, an oval electrode group is obtained.

In the case of a rectangular battery, an electrode group is produced by cutting the positive electrode and the negative electrode into a strip shape, alternately laminating the positive electrode and the negative electrode, and inserting a separator made of a polymer, such as polyethylene, polypropylene, or ethylene tetrafluoride, between the respective electrodes.

In addition, in order to improve the stability, a sandwich-shaped ceramic separator obtained by sandwiching the polymer-based separator with layers of electrically insulating ceramic particles, such as alumina, silica, titania, or zirconia, may be used as the separator.

The invention does not rely on the structure of the electrode group described above, and an arbitrary structure can be applied to the lithium ion battery according to the invention.

In addition, a mixture of at least one or more kinds selected from propylene carbonate, butylene carbonate, dimethyl carbonate, ethyl methyl carbonate, diethyl carbonate, methyl acetate, ethyl acetate, propyl acetate, methyl formate, ethyl formate, propyl formate, γ-butyrolactone, α-acetyl-γ-butyrolactone , α-methoxy-γ-butyrolactone, dioxolane, sulfolane, and ethylene sulfite can be used as the solvent in the electrolytic solution. A preferable electrolytic solution that can be used is a solution that contains a lithium salt electrolyte, such as LiPF₆, LiBF₄, LiSO₂CF₃, LiN[SO₂CF₃]₂, LiN[SO₂CF₂CF₃]₂, LiB[OCOCF₃]₄, or LiB[OCOCF₂CF₃]₄, in the above solvent in a volume concentration of approximately 0.5 M to 2 M.

The lithium ion battery can be produced by inserting the produced electrode group into a battery container made of aluminum, stainless steel, or nickel-plated steel, and then infiltrating the electrolytic solution into the electrode group. The shape of the battery can may be a cylindrical shape, a flat oval shape, a rectangular shape, and the like, and a battery can with any shape may be selected as long as the electrode group can be housed.

In order to suppress an increase in the irreversible capacity, the compound layer including the first carbon, the binder, and the viscosity improver was formed on the current collector without using the second carbon having a high specific surface area. As a result, an increase in the irreversible capacity could be suppressed, but the rate capability deteriorated. As a result of exploring the causes, it was confirmed that, when the compound layer near the current collector was observed using an SEM, excess binder and viscosity improver were locally present in the current collector. This is considered to be because the internal resistance between the compound layer and the current collector increased, and the high rate capability was impaired. In addition, a single layer of the compound layer including the first carbon, the second carbon, the binder and the viscosity improver was formed. Agglomerates including the second carbon contain the binder and the viscosity improver, and form a complex state of the second carbon and the binder. The agglomerates develop the binding force, and also have electron conductivity. Furthermore, when the agglomerates of the second carbon are well observed, the primary grain diameter of the second carbon is generally 50 nm, but the primary grain diameter of the agglomerates increases to a micron order. This is because the second carbon has a large specific surface area, and easily absorbs the binder and the viscosity improver.

In order to utilize the above property, the negative electrode having the lower compound layer that includes the first carbon and the viscosity improver formed on the current collector, and, furthermore, the upper compound layer that includes the second carbon, the binder, and the viscosity improver formed on the lower compound layer was produced. As a result, SEM observation of the compound layer near the current collector confirms that excess binder and viscosity improver are not locally present in the current collector. The specific method of manufacturing the negative electrode will be described in the examples.

The reason why the thickness of the lower compound layer is made to be two or more times the surface roughness (average roughness of ten points) Rz of the current collector is that, when the thickness of the lower compound layer is less than two times the surface roughness Rz of the current collector, the upper compound layer is formed on the protrusion portions of the current collector in a state in which the protrusion portions are exposed, and the irreversible capacity increases. Therefore, the compound layer preferably includes no second carbon on the current collector side from the viewpoint of suppressing an increase in the irreversible capacity. As a result, it is important to prevent the upper compound layer including the second carbon, the binder, and the viscosity improver from coming into contact with the protrusion portions that form the surface roughness of the current collector.

### EXAMPLE 1

FIG. 5 shows a cross section of a coin-form lithium secondary battery 301 of the invention. The coin-form lithium secondary battery 301 is structured to be sealed by a positive electrode can 334, a negative electrode can 335, and a gasket 336. In the battery, a positive electrode 307, a negative electrode 308, a separator 309, and an electrolytic solution are housed. The electrolytic solution is held in the separator 309 and a space 337 in the battery. The positive electrode 307 includes a positive electrode compound layer 330 and a positive electrode current collector 331. The negative electrode 308 includes a negative electrode compound layer 332 and a negative electrode current collector 333. The negative electrode compound layer 332 includes a lower negative electrode compound layer 340 and an upper negative electrode compound layer 341.

Hereinafter, the positive electrode 307, the negative electrode 308, and a method of assembling a coin-type battery will be sequentially described.

The positive electrode active material that is used in the present example is Li_{1.05}Mn_{1.9504} having an average grain diameter of 20 μm. A mixture of natural graphite having an average grain diameter of 3 μm and a specific surface area of 13 m²/g and carbon black having an average grain diameter of 0.04 μm and a specific surface area of 40 m²/g which were mixed in a weight ratio of 4:1 was used as the conducting material. A solution of 8 wt % of poly (vinylidene fluoride) (PVDF) previously dissolved in N-methyl-2-pyrrolidone was used as the binder.

The positive electrode active material, the conducting material, and the PVDF were mixed in a weight ratio of 90:4:6, and sufficiently stirred so as to prepare a positive electrode slurry. The positive electrode slurry was coated and dried on a single surface of the positive electrode current collector 331 including a 20 μm-thick aluminum foil so that the positive electrode compound layer 330 could be formed on the positive electrode current collector 331. The positive electrode 307 was pressed using a roll pressing machine, and the positive electrode compound layer 330 was compressed. Thereby, the internal resistance of the positive electrode compound layer 330 was decreased, and the interface contact resistance between the positive electrode compound layer 330 and the positive electrode current collector 331 was also decreased. The electrode was cut out into a disc shape having a diameter of 15 mm so as to prepare the positive electrode 307.

The negative electrode 308 was produced by the following method. Natural graphite having an average grain diameter of 10 μm and, as a viscosity improver, CMC were mixed with the first carbon of the negative electrode so as to obtain a lower compound layer slurry. The lower compound layer slurry was coated and preliminarily dried on a single surface of the negative electrode current collector 333 including a 10 μm-thick copper foil so as to obtain the lower negative electrode compound layer 340 on the negative electrode current collector 333. Next, carbon black having an average grain diameter of 0.04 μm and a specific surface area of 40 m²/g, styrene butadiene rubber as a binder, and carboxymethyl cellulose (CMC) as a viscosity improver were mixed with the second carbon so as to obtain an upper compound layer slurry. The upper compound layer slurry was coated and preliminarily dried on the lower negative electrode compound layer 340 formed on the negative electrode current collector 333 so as to obtain the upper negative electrode compound layer 341. Thereby, the negative electrode current collector 333 on which the lower negative electrode compound layer 340 and the upper negative electrode compound layer 341 were formed was pressed through roll pressing, and then dried so as to produce an electrode. The electrode was cut out into a disc shape having a diameter of 16 mm so as to prepare the negative electrode 308.

Here, the cross-sectional state of the negative electrode was observed using a scanning electron microscope (SEM), energy dispersive X-ray spectroscopy (EDX), and an electron probe micro analyzer (EPMA) so as to create differences in the areas of the second carbon and binder agglomerates with respect to the entire cross-sectional area of the lower negative electrode compound layer 340. Furthermore, a stain is preferably used for a pretreatment of SEM so that the binder and the viscosity improver can be differentiated. For example, in a case in which the binder is SBR, osmium tetraoxide having a characteristic of adding osmium to butadiene-derived double bond portions can be used. In a case in which the viscosity improver is CMC, the viscosity improver can be stained using ruthenium tetraoxide. In the example, osmium tetraoxide was used as the stain in order to obtain the area fraction of the binder.

The area fraction of the second carbon and the binder agglomerates with respect to the entire area of the SEM image can be obtained by analyzing grain shapes using a well-known image-processing software (for example, A ZOKUN (R), manufactured by Asahi Kasei Engineering Corporation).

The image-processing software applied to the invention preferably has an application that can automatically separate and recognize each of grains on the image so as to measure the area of the grains. In addition, the software more desirably has functions that can measure area fractions, the maximum length and minimum width of areas, and the number of grains.

The sequence of obtaining the area is as follows. In the SEM image and the osmium-detected mapping obtained by EDX, a plurality of the first carbon grains, a plurality of the second carbon grains, and a plurality of the binder grains which have different grain diameters are shown. There are compound layers in which the second carbon grains form agglomerates and compound layers in which the sizes of the second carbon agglomerates are different. In addition, compound layers independently formed of the second carbon grains are shown. Local presence of the binder and CMC between the first carbon grains is also shown. Firstly, the plurality of the second carbon grains in the image of the negative electrode compound layer cross section that is obtained using an SEM is stained so that the plurality of the first carbon grains and the plurality of the second carbon grains can be differentiated. The grains are preferably stained at as high a magnification as possible in an image that is scanned using arbitrary image-processing software. This is because, when the grains are stained at the same magnification as for the image obtained using an SEM, an artificial error increases.

Furthermore, it is difficult to binarize the image as it is, which is obtained using an SEM, since the binarization threshold is not specified. Staining facilitates image processing, and the high reliability of the data can be obtained. It is preferable to apply a difference in the contrast between the negative electrode active material (first carbon) and the second carbon in the SEM image under an SEM observation condition of a low accelerating voltage so as to facilitate the image processing. Next, the stained area was obtained in a fixed area of 10 μm in the compound layer thickness direction and 30 μm in the horizontal direction on the image-processed image. The stained portion corresponds to a portion not including the first carbon, the binder, CMC, and the space, that is, the second carbon. The image was divided at intervals of 10 μm in the compound layer thickness direction, and analyzed. The compound layer thickness direction, the horizontal direction, and the analysis area are specified as shown in FIG. 8.

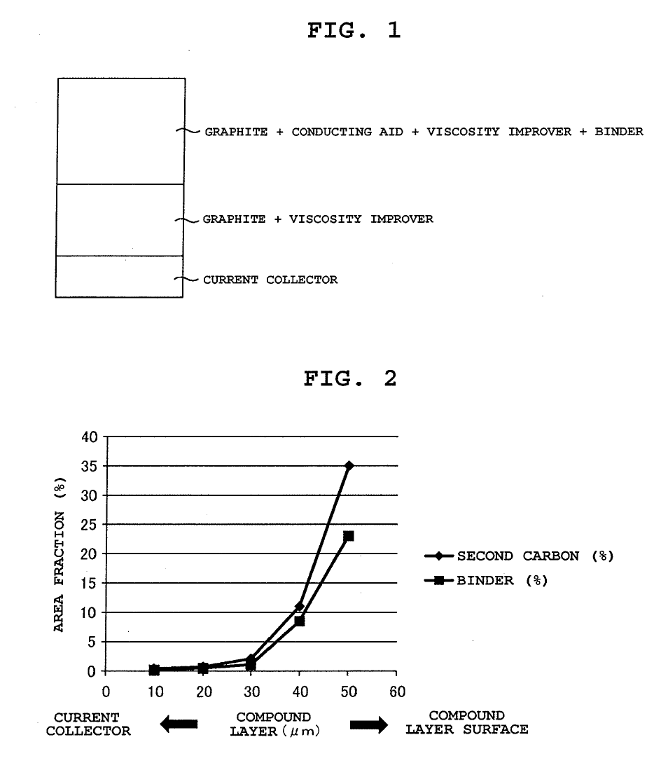

In addition, the area of the osmium mapping in which the osmium tetraoxide-stained compound layer cross section was analyzed by EDX was obtained at the same analysis area and magnification as in the above SEM image. The analysis area was fixed to be 10 μm in the compound layer thickness direction and 30 μm in the horizontal direction. In addition, similarly to the above, the image was divided at intervals of 10 μm in the compound layer thickness direction, and analyzed. The summary of the above is shown in FIG. 2. Ten micrometers of the horizontal axis in the thickness direction refers to an area that is 0 μm to 10 μm from the current collector surface toward the compound layer surface and 30 μm in the horizontal direction, and 50 μm in the thickness direction refers to an area that is 40 μm to 50 μm from the current collector surface toward the compound layer surface and 30 μm in the horizontal direction. It is found that the second carbon and the binder both increase from the current collector surface toward the compound layer surface. This is because the upper compound layer slurry is coated on the lower compound layer that is coated and preliminarily dried on the current collector so that the second carbon and the binder in the upper compound layer slurry soak toward the current collector, and therefore the second carbon and the binder are slightly present on the current collector side of the lower compound layer. In addition, it is confirmed that excess binder and viscosity improver are not locally present in the current collector. That is, in the case of the negative electrode produced in Example 1, the area fractions of the second carbon and the binder are different by 34.6% and 22.80 respectively in the compound layer having an area of 40 μm to 50 μm from the current collector surface toward the compound layer surface side (corresponds to the compound layer surface layer) compared to the compound layer having an area of 0 μm to 10 μm from the current collector surface toward the compound layer surface and 30 μm in the horizontal direction (corresponds to the current collector side of the compound layer) , which becomes two times or more.

The case of a single layer of Comparative Example 1 is shown in FIG. 3. The second carbon and the binder clearly show large peaks near the current collector, which indicates that the second carbon and the binder are locally present. It is found that the second carbon and the binder are most included in the compound layer on the current collector side in the case of Comparative Example 1 and in the compound layer surface layer in the case of Example 1.

Next, the coin-type lithium ion battery 301 shown in FIG. 5 was assembled using a negative electrode in which the compound layer was compressed using a roll pressing machine. The positive electrode 307, the separator 309, and the negative electrode 308 were laminated, and the laminate was housed in the positive electrode can 334 and the negative electrode can 335. The separator 309 is a 40 μm-thick polyethylene porous polymer sheet. A liquid mixture having 1.0 mol/dm³ of LiPF₆ dissolved in a liquid mixture of ethylene carbonate and ethyl methyl carbonate (in a volume ratio of 1:2) was used as the electrolytic solution. The electrolytic solution was present in the separator 309 and a space 337 in the battery. The battery was compressed from outside using a swaging machine so as to complete the coin-type lithium ion battery 301.

For the coin-type lithium ion battery 301 shown in Example 1, charge and discharge tests were carried out in an environment of a temperature of 45° C. under the following conditions. Firstly, constant current and constant voltage charge, in which the battery was charged to a voltage of 4.1 V with a constant current having a current density of 1 mA/cm², and then charged with a constant voltage at 4.1 V, was carried out for three hours. After the charge was finished, the battery was rested for one hour so as to be discharged to a discharge-finish voltage of 3 V with a constant current of 1 mA/cm² to 21 mA/cm². After the discharge was finished, the battery was rested for two hours. Charge, rest, discharge, and rest were repeated, and the constant current was increased in a step-by-step manner, thereby carrying out rate tests. The discharge capacity of the lithium ion battery was compared at 21 mA/cm² (7 C) in the rate tests.

### EXAMPLES 2 TO 4

Negative electrodes were produced by changing the weight ratio of the first carbon and the second carbon in the upper compound layer and the thickness of the upper compound layer in the negative electrode 308 that was produced in Example 1. The binder and the viscosity improver being added were also changed. Natural graphite having an average grain diameter of 10 μm and CMC as the viscosity improver were mixed with the first carbon in the negative electrode so as to obtain lower compound layer slurry. The lower compound layer slurry was coated and preliminarily dried on a single surface of the negative electrode current collector 333 including a 10 μm-thick copper foil so as to obtain the lower negative electrode compound layer 340 on the negative electrode current collector 333. Next, mechanically mixed substances of natural graphite having an average grain diameter of 20 μm and carbon black having an average grain diameter of 0.04 μm and a specific surface area of 40 m²/g were used as the first carbon and the second carbon respectively. Styrene butadiene rubber as a binder and CMC as the viscosity improver were mixed so as to obtain upper compound layer slurry. The upper compound layer slurry was coated and preliminarily dried on the lower negative electrode compound layer 340 formed on the negative electrode current collector 333 so as to obtain the upper negative electrode compound layer 341. Thereby, the negative electrode current collector 333 on which the lower negative electrode compound layer 340 and the upper negative electrode compound layer 341 were formed was pressed through roll pressing, and then dried so as to produce an electrode. The electrode was cut out into a disc shape having a diameter of 16 mm so as to prepare the negative electrode 308. For the negative electrode, the positive electrode 307, the separator 309, the electrolytic solution, the positive electrode can 334, the negative electrode can 335, and the gasket 336, which were the same as in Example 1, were used so as to produce the coin-type lithium ion battery 301 in FIG. 5.

### EXAMPLE 5

In order to improve the separation strength of the current collector and the compound layer, the difference in the surface roughness of the current collector was investigated. The current collector having a surface roughness Rz of 1.0 μm was used in Examples 1 and 2, but a current collector having a surface roughness of 5.0 μm was used in Example 5. Except the above, the methods of manufacturing the negative electrode and the positive electrode were the same as in Example 2. The positive electrode 307, the separator 309, the electrolytic solution, the positive electrode can 334, the negative electrode can 335, and the gasket 336, which were the same as in Example 1, were used so as to produce the coin-type lithium ion battery 301 in FIG. 5.

### EXAMPLE 6

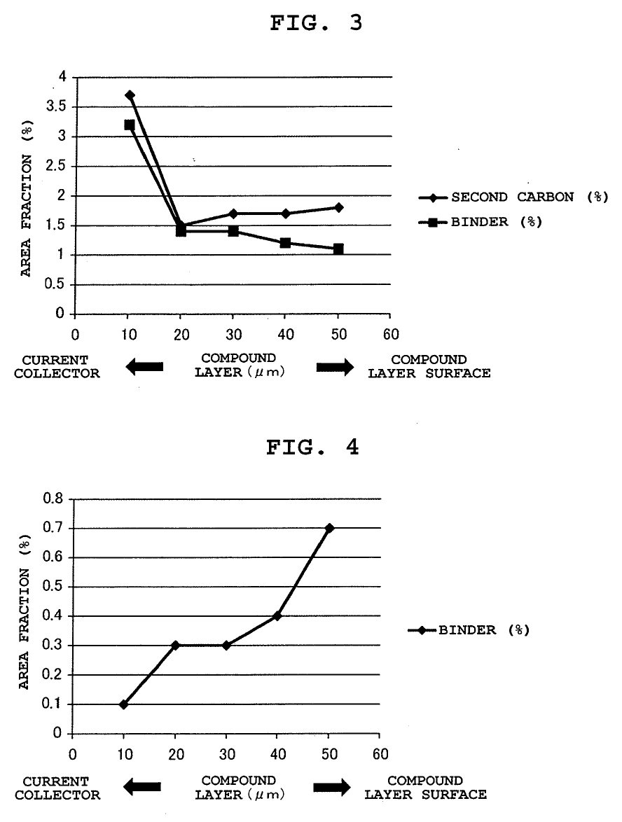

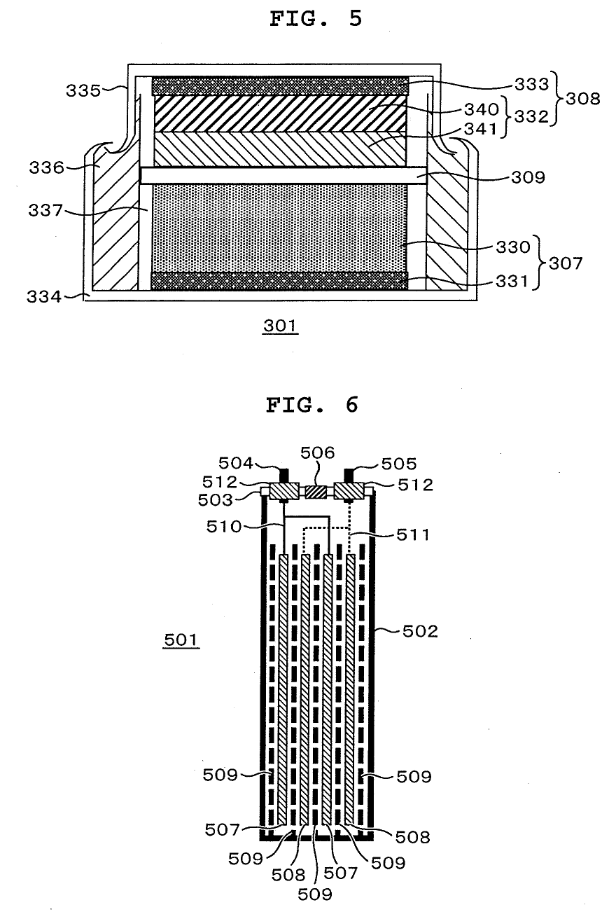

Instead of EDX analysis, the binder was point-analyzed using EPMA. The electron beam diameter was set to φ1 μm. Surface analysis is available by scanning electron beams to a predetermined analysis area. The analysis area was fixed to 10 μm², and the image was analyzed at 10 μm intervals from the current collector surface toward the compound layer surface. In order to obtain the area fraction of the binder, the compound layer cross section was stained using osmium tetraoxide as a stain. The area fraction of the binder excludes the first carbon, the second carbon, CMC, and the space. The area of the second carbon was obtained in the same manner as in Example 1. The summary is shown in FIG. 4.

### COMPARATIVE EXAMPLE 1

In reality, the second carbon has a large specific surface area, and therefore the second carbon easily absorbs the binder and the viscosity improver, and the irreversible capacity increases. As Comparative Example 1, a single layer was produced as follows.

Natural graphite having an average grain diameter of 10 μm was used as the first carbon of the negative electrode, carbon black having an average grain diameter of 0.04 μm and a specific surface area of 40 m²/g was used as the second carbon, carboxymethyl cellulose (CMC) was used as the viscosity improver, and styrene butadiene rubber was used as the binder. A substance obtained by mixing previously mixed graphite, a carbon material including carbon black, carboxymethyl cellulose (CMC), and styrene butadiene rubber so that the weight ratio became 95:3:1:1 and sufficiently stirring the mixture was used as a negative electrode slurry. Purified water was added to the slurry so that the ratio of the solid content including the active material, the carbon black, the binder, and the viscosity improver became within a range of 35% to 50%. The positive electrode was produced with the same composition and manufacturing method as in Example 1.

### COMPARATIVE EXAMPLE 2

The second carbon was included in the lower compound layer, and an increase in the irreversible capacity was investigated. The negative electrode 308 was produced by the following method. Natural graphite having an average grain diameter of 10 μm, carbon black having an average grain diameter of 0.04 μm and a specific surface area of 40 m²/g, and carboxymethyl cellulose (CMC) were mixed as the first carbon of the negative electrode, the second carbon, and the viscosity improver respectively so as to obtain a lower compound layer slurry. The lower compound layer slurry was coated and preliminarily dried on a single surface of the negative electrode current collector 333 including a 10 μm-thick copper foil so as to obtain the lower negative electrode compound layer 340 on the negative electrode current collector 333. Next, natural graphite having an average grain diameter of 20 μm for the first carbon, carbon black having an average grain diameter of 0.04 μm and a specific surface area of 40 m²/g for the second carbon, styrene butadiene rubber as a binder, and carboxymethyl cellulose (CMC) as a viscosity improver were mixed so as to obtain upper compound layer slurry. The upper compound layer slurry was coated and preliminarily dried on the lower negative electrode compound layer 340 formed on the negative electrode current collector 333 so as to obtain the upper negative electrode compound layer 341. Thereby, the negative electrode current collector 333 on which the lower compound layer 340 and the upper compound layer 341 were formed was pressed through roll pressing, and then dried so as to produce an electrode. The electrode was cut out into a disc shape having a diameter of 16 mm so as to prepare the negative electrode 308. For the negative electrode, the positive electrode 307, the separator 309, the electrolytic solution, the positive electrode can 334, the negative electrode can 335, and the gasket 336, which were the same as in Example 1, were used so as to produce the coin-type lithium ion battery 301 in FIG. 4.

### COMPAATIVE EXAMPLE 3

A negative electrode was manufactured so that the difference in the surface roughness of the current collector and the thickness of the lower compound layer could be compared to Example 3. Except the above, the methods of manufacturing the negative electrode and the positive electrode are the same as in Example 3. The thicknesses of the lower compound layer and the upper compound layer of the negative electrode were 8 μm and 42 μm.

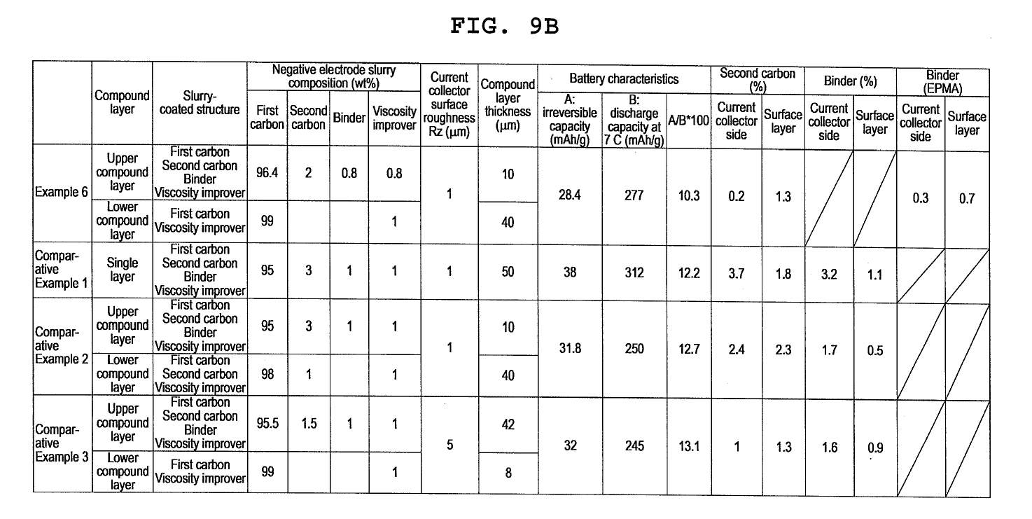

The battery characteristics of Examples 1 to 6 and Comparative Examples 1 to 3 are summarized in FIGS. 9A and 9B. A: irreversible capacity (mAh/g) was obtained from the difference in the initial charge and discharge capacity. B: the discharge capacity at 7 C (21 mA/cm²). A/B*100 is the proportion obtained by dividing the irreversible capacity by the discharge capacity at 7 C, and the charge and discharge capacity can be said to increase as A/B*100 decreases. The rate capability is the maintenance rate of the battery capacity when the current density is changed, and the battery can tolerate more abrupt charge and discharge capacity as the rate capability increases. Next, the difference in the area ratio between the second carbon and the binder in the current collector side of the compound layer including the lower and upper compound layers (the compound layer in a range of 10 μm from the current collector surface toward the compound layer surface) and the compound layer surface layer (the compound layer in a range of 10 μm from the compound layer surface toward the current collector) is 1.1% to 34.6% for the second carbon and 1.3% to 22.8% for the binder while the added amounts of the second carbon and the binder are different, and the area ratio in the compound layer surface layer is higher.

On the other hand, for Comparative Examples 1 to 3, the difference in the area fraction between the second carbon and the binder in the current collector side of the compound layer and the compound layer surface layer is not large, and the area ratio in the current collector side of the compound layer is higher.

It was found that the irreversible capacity was smaller in Examples 1 to 6 than Comparative Examples 1 to 3, which indicates that the irreversible capacity improved. Specifically, the irreversible capacity is smaller than 31.8 mAh/g, and is 29.8 mAh/g or less in Examples 1 to 6. A/B*100 is smaller than 12.2, and was 10.5 or less in Examples 1 to 6, which indicates that A/B*100 was suppressed to be low compared to Comparative Examples 1 to 3.

The reasons why an increase in the irreversible capacity is suppressed, and the rate capability is improved are considered as follows. In Comparative Examples 1 to 3, since the second carbon easily absorbs the highly insulating binder, the binder is liable to be locally present in the current collector. It is considered that, due to the above fact, the internal resistance between the compound layer and the current collector increases, and the rate capability is adversely affected. In contrast to the above, in all of Examples 1 to 6, the second carbon is not present in the compound layer close to the current collector. Therefore, it is considered that it becomes difficult for the binder to be locally present in the current collector even when the binder is locally present between the first carbon grains, and the rate capability improves.

Like Examples 1 to 6, in the film thickness direction of the negative electrode compound layer 332, when the distance from the interface between the negative electrode current collector 333 and the negative electrode compound layer 332 toward the surface of the negative electrode compound layer 332 is represented by d₁, and the distance from the surface of the negative electrode compound layer 332 toward the interface between the negative electrode current collector 333 and the negative electrode compound layer 332 is represented by d₂, the irreversible capacity can be improved by making the average area fraction of the second carbon and the binder in the negative electrode compound layer 332 in 0 μm≦d₁≦10μm two times or more, preferably four times or more, and more preferably five times or more the average area fraction of the second carbon and the binder in the negative electrode compound layer 332 in 0 μm≦d₂≦10 μm.

Like Examples 2 to 4, in a case in which the first carbon and the second carbon are included in the upper negative electrode compound layer 341, the capacity can be increased by making the content of the first carbon larger than the content of the second carbon. In this case, it is desirable that the content of the second carbon in the negative electrode compound layer 332 be 1 wt % to 6 wt %, and preferably 1.5 wt % to 5 wt %. When the content of the second carbon becomes larger than 6 wt %, there is a possibility of an increase in the irreversible capacity.

Like Examples 3 to 5, even when the film thickness of the upper negative electrode compound layer 341 is made to be larger than the film thickness of the lower negative electrode compound layer 340, it is possible to suppress the second carbon and the binder from being locally present near the current collector. Specifically, it is preferable that the film thickness of the upper negative electrode compound layer 341 be two times or more and desirably four times or more the film thickness of the lower negative electrode compound layer 340.

In addition, as is clear from FIGS. 9A and 9B, with regard to the optimal thicknesses of the lower compound layer and the upper compound layer, the thickness of the lower compound layer is preferably 10 μm or more in a case in which the surface roughness Rz of the current collector is 5 μm (Example 5) . When the thickness of the lower compound layer is less than 10 μm, the second carbon and the binder become liable to be locally present on the current collector side (Comparative Example 3). That is, it is desirable that the thickness of the lower compound layer be two times or more, preferably 10 times or more, and more preferably 40 times or more the surface roughness Rz of the current collector.

As such, it is possible to suppress an increase in the irreversible capacity and improve the rate capability by limiting the content of the second carbon in the current collector. The invention exhibits the effects particularly in lithium secondary batteries having a large discharge capacity.

In the examples described above, the coin-type lithium ion batteries were exemplified. The shapes of the batteries, battery specifications, and the like can be arbitrarily modified within the scope of the purport of the invention, and the invention is not limited to the examples.

### EXAMPLE 7

FIG. 6 schematically shows the internal structure of a non-aqueous electrolyte secondary battery 501. The non-aqueous electrolyte secondary battery 501 collectively refers to electrochemical devices in which electric energy can be stored and used through absorption and emission of ions to and from the electrode in a non-aqueous electrolyte. In the present example, description will be made using a lithium ion battery as a typical example.

In the non-aqueous electrolyte secondary battery 501 of FIG. 6, an electrode group including a positive electrode 507, a negative electrode 508, and a separator 509 that is inserted between both electrodes is housed in a battery container 502 in a sealed state. A lid 503 is present on the top portion of the battery container 502, and the lid 503 has a positive electrode external terminal 504, a negative electrode external terminal 505, and an injection opening 506. After the electrode group is housed in the battery container 502, the battery container 502 is covered with the lid 503, and the lid 503 is welded at the outer circumference so as to be integrated with the battery container 502. In order to attach the lid 503 to the battery container 502, a method other than welding, such as swaging or adhesion, can be employed.

The top portion of the laminate is electrically connected to the external terminals through lead wires. The positive electrode 507 is connected to the positive electrode external terminal 504 through a positive electrode lead wire 510. The negative electrode 508 is connected to the negative electrode external terminal 505 through a negative electrode lead wire 511. Meanwhile, the lead wires 510 and 511 can employ an arbitrary shape, such as a wire shape or a sheet shape. The shapes and materials of the lead wires 510 and 511 are arbitrary as long as the structure can decrease the ohmic loss when electric currents are made to flow, and the material does not react with the electrolytic solution.

In addition, an insulating seal material 512 is inserted between the positive electrode external terminal 504 or the negative electrode external terminal 505 and the battery container 502 so as to prevent both terminals from short-circuiting through the lid 503. Any of a fluororesin, a thermosetting resin, a glass hermetic seal, and the like can be selected as the insulating seal material 512, and an arbitrary material that does not react with the electrolytic solution and is excellent in terms of air-tightness can be used.

In the example, the following test was carried out using a positive electrode that was manufactured using a positive electrode active material LiNi_{1/3}Mn_{1/3}CO_{1/3}O₂ having an average grain diameter of 10 μm, carbon black as the conducting material, and poly (vinylidene fluoride) (PVDF) as the binder. The weight composition of the positive electrode active material, the conducting material, and the binder was set to 88:7:5. The electrode area on which the positive electrode slurry was coated was set to 10 cm×10 cm, and the compound layer thickness was set to 70 μm. The negative electrode was manufactured as shown in Example 4. The electrode area was set to 10 cm×10 cm, and the compound layer was set to 50 μm. A liquid mixture having 1.0 mol/dm³ of LiPF₆ dissolved in a liquid mixture of ethylene carbonate and ethyl methyl carbonate (in a volume ratio of 1:2) was used as the electrolytic solution. A plurality of rectangular batteries shown in FIG. 6 was manufactured.

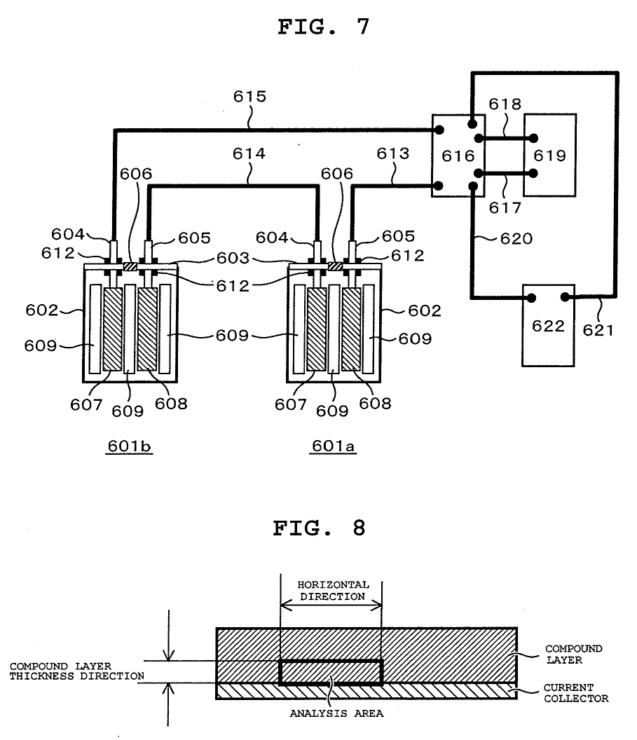

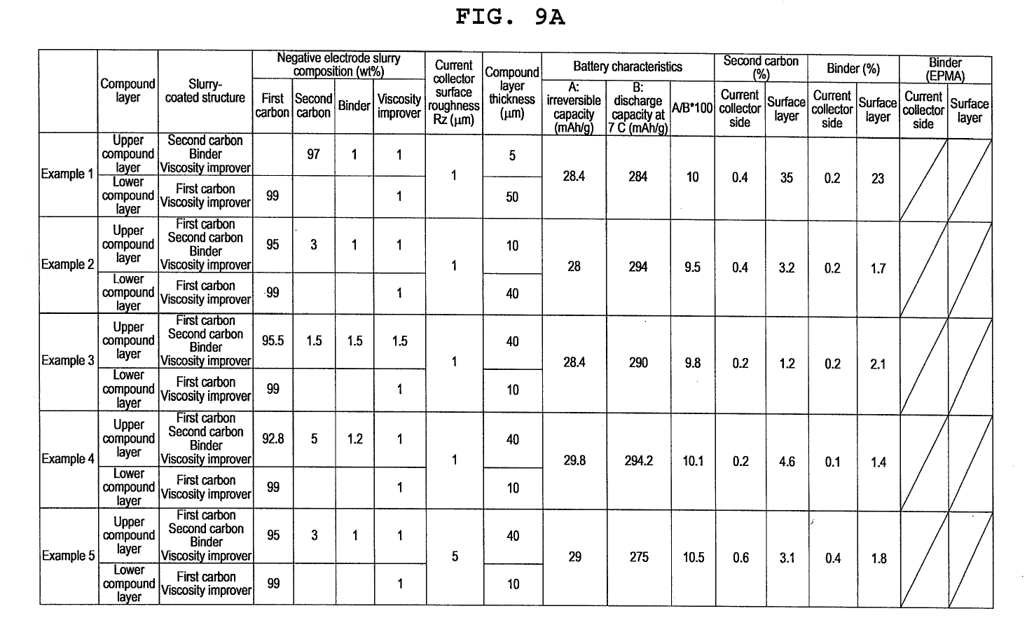

Next, FIG. 7 shows the battery system of the invention in which two non-aqueous electrolyte secondary batteries 601a and 601b that were manufactured as shown in FIG. 6 were connected in series. The number of the batteries in series and in parallel can be arbitrarily modified depending on the voltage or capacity that the system requires.

The respective non-aqueous electrolyte secondary batteries 601a and 601b have a structure in which an electrode group that includes a positive electrode 607, a negative electrode 608, and a separator 609, and has the same specification is inserted in a battery container 602, and a positive electrode external terminal 604 and a negative electrode external terminal 605 are provided on the top surface of lids 603. An insulating seal material 612 is inserted between the lids 603 of the external terminals 604 and 605 so as to prevent the external terminals from short-circuiting through the lids 603. In the drawing, one positive electrode and one negative electrode are shown; however, in reality, 20 sheets of the positive electrodes 607 and the negative electrodes 608 are alternately laminated through the separators 609. The number of the electrodes is set so that the insulating seal material 612 is inserted between the respective external terminals and the battery container 602 so as to prevent the external terminals from short-circuiting. Meanwhile, in the drawing, components corresponding to the positive electrode lead wire 610 and the negative electrode lead wire 611 of FIG. 6 are not shown, but the internal structure of the non-aqueous electrolyte secondary batteries 601a and 601b are the same as in FIG. 6. An injection opening 606 is provided on the top portion of the lid 603.

The negative electrode external terminal 605 in the non-aqueous electrolyte secondary battery 601a is connected to a negative electrode input terminal in a charge and discharge controller 616 through a power cable 613. The positive electrode external terminal 604 in the non-aqueous electrolyte secondary battery 601a is coupled to the negative electrode external terminal 605 in the non-aqueous electrolyte secondary battery 601b through a power cable 614. The positive electrode external terminal 604 in the non-aqueous electrolyte secondary battery 601b is connected to a positive electrode input terminal in the charge and discharge controller 616 through a power cable 615. Such a wire configuration enables charging or discharging of two non-aqueous electrolyte secondary batteries 601a and 601b.

The charge and discharge controller 616 performs power transfer with a device (hereinafter referred to as an external device) 619 that is installed outside through power cables 617 and 618. The external device 619 includes a variety of electric devices, such as an external power supply and a regeneration motor for supplying electricity to the charge and discharge controller 616, an inverter, a converter, and a load which supply power to the present system. The external device may be provided with an inverter and the like depending on the kind of corresponding alternate current and direct current. A well-known device can be arbitrarily applied as the device.

In addition, a power generation apparatus 622 that simulates the operation conditions of a wind power generator may be installed as a device that generates recyclable energy, and connected to the charge and discharge controller 616 through power cables 620 and 621. When the power generation apparatus 622 generates power, the charge and discharge controller 616 switches to a charge mode, supplies electricity to the external device 619, and charges excess power in the non-aqueous electrolyte secondary batteries 601a and 601b. In addition, when the amount of power generated, which simulates a wind power generator, is smaller than the demand power of the external device 619, the charge and discharge controller 616 operates so as to discharge the non-aqueous electrolyte secondary batteries 601a and 601b. Meanwhile, the power generation apparatus 622 can be substituted into other power generation apparatuses, that is, an arbitrary apparatus, such as a solar battery, a geothermal power generation apparatus, a fuel battery, or a gas turbine power generator. The charge and discharge controller 616 is made to save a program that can automatically operate so as to carry out the above operations.

The non-aqueous electrolyte secondary batteries 601a and 601b are subjected to ordinary charge so as to obtain the rating capacity. For example, a constant voltage charge of 4.1 V or 4.2 V can be carried out for 0.5 hours using a one hour rate-charge current. Since the charge conditions are determined depending on design of the kinds and used amount of the materials of the lithium ion battery, the conditions are optimized for the respective specifications of the battery.

After the non-aqueous electrolyte secondary batteries 601a and 601b are charged, the charge and discharge controller 616 is switched to a discharge mode, and the respective batteries are discharged. Generally, the discharge is stopped when a certain lower limit voltage is reached.

The system described above was used as S1, and the external device 619 supplied power during charge and was made to consume power during discharge. In the example, up to 5 hour rate-discharge was carried out, and high capacity, which was 90%, was obtained with respect to the capacity during one hour rate discharge. Capacity degradation was not substantially observed when 100 instances of the charge and discharge cycle were carried out, and the capacity was maintained at 90% under the above conditions. In addition, the power generation apparatus 622 that simulated the wind power generator could carry out 3 hour rate-charge during powder generation.

Based on the contents described above, the respective specific examples will be shown, and the effects of the invention will be clarified. Meanwhile, the specific configuration materials, components, and the like may be modified within the scope of the purport of the invention. In addition, as long as the configuration elements of the invention are included, it is possible to add well-known techniques or substitute with well-known techniques, and the power generation apparatus can be substituted into an arbitrary recyclable power generation system, such as solar, geothermal, or wave energy.

### COMPARATIVE EXAMPLE 4

A negative electrode was manufactured using the composition of the negative electrode in Comparative Example 1, and a plurality of the lithium ion batteries shown in FIG. 6 was manufactured. According to the comparative example, the system of FIG. 7 was manufactured using negative electrodes that were once coated with slurry obtained by stirring and dispersing the first and second carbon, the binder, and CMC with other conditions that are the same conditions as in Example 7.

Using the above system, the external device 619 supplied power during charge, and was made to consume power during discharge. In the present example, up to 5 hour rate-discharge was carried out, and high capacity, which was 90%, was obtained with respect to the capacity during one hour rate-discharge at the initial 10 cycles. However, compared to Example 7, the irreversible capacity was large by 28%, and the capacity was degraded by 20%.

Use of the non-aqueous electrolyte secondary battery of the invention is not particularly limited. For example, use is possible as a power supply of mobile information communication devices, such as personal computers, word processors, cordless telephone handsets, electronic book readers, mobile phones, car phones, handy terminals, transceivers, and portable radios. In addition, use is possible as a power supply of a variety of mobile devices, such as portable copy machines, electronic diaries, calculators, liquid crystal televisions, radios, tape recorders, headphone stereos, portable CD players, video movies, electric shavers, electronic translating machines, voice-input devices, and memory cards. In addition, use is possible as domestic electric devices, such as refrigerators, air conditioners, televisions, stereos, water heaters, oven microwaves, dish washers, dryers, laundry machines, lighting devices, and toys. In addition, use is possible as a battery for domestic and business electric power tools and nursing tools (electric power wheelchairs, electric power beds, electric power bathing facilities, and the like). Furthermore, the invention can be applied as an industrial power supply for medical devices, construction machines, power storage systems, elevators, and unmanned moving vehicles, and, furthermore, as a power supply for moving bodies, such as electric vehicles, hybrid electric vehicles, plug-in hybrid electric vehicles, golf carts, and turret cars. Furthermore, use is also possible as a power storage system which can charge power generated from a solar battery or a fuel battery in the battery module of the invention, and use the power above the earth, such as in space stations, space shuttles, and space bases. The contents of the invention are desirably used for vehicles for which abrupt charge and discharge (favorable rate capability) is required and industrial use for which an increase in the capacity is required.

What is claimed is:

1. A non-aqueous electrolyte secondary battery negative electrode comprising:
a negative electrode compound layer formed on a current collector,
wherein the negative electrode compound layer is constituted by a lower negative electrode compound layer and an upper negative electrode compound layer, the lower negative electrode compound layer is formed on the current collector, the upper negative electrode compound layer is formed on the lower negative electrode compound layer, the lower negative electrode compound layer includes a negative electrode active material, the upper negative electrode compound layer includes a conducting material and a binder, and a conducting aid and the binder are locally present on the surface side of the upper negative electrode compound layer.

2. The non-aqueous electrolyte secondary battery negative electrode according to claim 1,
wherein the upper negative electrode compound layer includes the negative electrode active material, and
the content of the negative electrode active material in the upper negative electrode compound layer is larger than the content of the conducting material in the upper negative electrode compound layer.

3. The non-aqueous electrolyte secondary battery negative, electrode according to claim 2,
wherein the content of the conducting material in the negative electrode compound layer is 1 wt % to 6 wt %.

4. The non-aqueous electrolyte secondary battery negative electrode according to claim 1,
wherein the film thickness of the upper negative electrode compound layer is larger than the film thickness of the lower negative electrode compound layer.

5. The non-aqueous electrolyte secondary battery negative electrode according to claim 1,
wherein the content of the binder in the negative electrode compound layer is 0.5 wt % to 2.0 wt %.

6. The non-aqueous electrolyte secondary battery negative electrode according to claim 1,
wherein the thickness of the lower negative electrode compound layer is two times or more the surface roughness of the current collector.

7. The non-aqueous electrolyte secondary battery negative electrode according to claim 1,
wherein, when the distance from an interface between the current collector and the negative electrode compound layer toward the surface of the negative electrode compound layer is represented by d₁ in the film thickness direction of the negative electrode compound layer, and
the distance from the surface of the negative electrode compound layer toward the interface between the current collector and the negative electrode compound layer is represented by d₂ in the film thickness direction of the negative electrode compound layer,
the average area fraction of the conducting material and the binder in the negative electrode compound layer in 0 μm≦d₁≦10 μm is two times or more the average area fraction of the conducting material and the binder in the negative electrode compound layer in 0 μm≦d₂≦10 μm.

8. The non-aqueous electrolyte secondary battery negative electrode according to claim 1,
wherein the negative electrode compound layer includes a viscosity improver.

9. A non-aqueous electrolyte secondary battery,
wherein the non-aqueous electrolyte secondary battery negative electrode according to claim 1 is used.

10. A battery module,
wherein a plurality of the non-aqueous electrolyte secondary batteries according to claim 9 is used.

11. A method of manufacturing a non-aqueous electrolyte secondary battery negative electrode having a negative electrode compound layer formed on a current collector comprising:
a process of forming a lower negative electrode compound layer which includes a negative electrode active material, and does not include a conducting material, and a binder on the current collector; and
a process of forming an upper negative electrode compound layer which includes a conducting material and a binder on the lower negative electrode compound layer,
wherein a conducting aid and the binder are locally present on the surface side of the upper negative electrode compound layer.
